(19) United States
(12) Patent Application Publication
(10) Pub. No.: US 2012/0049983 A1
(43) Pub. Date: Mar. 1, 2012

(54) DIPLEXER, AND RESONATOR FILTERS COMBINED WITH DUAL MODE AND TRIPLE-MODE RESONATORS

(75) Inventors: Man Seok Uhm, Daejeon (KR); Chang Soo Kwak, Daejeon (KR); So Hyeun Yun, Daejeon (KR); Jang Sup Choi, Daejeon (KR); In Bok Yom, Daejeon (KR)

(73) Assignee: ELECTRONICS AND TELECOMMUNICATIONS RESEARCH INSTITUTE, Daejeon (KR)

(21) Appl. No.: 13/173,373

(22) Filed: Jun. 30, 2011

(30) Foreign Application Priority Data
Jul. 2, 2010 (KR) 10-2010-0063719
Dec. 10, 2010 (KR) 10-2010-0126045

(51) Int. Cl. H01P 1/208

(52) U.S. Cl. 333/212

(57) ABSTRACT

A 7 pole resonator filter including a dual mode resonator and a triple mode resonator may include a first dual mode resonator including independent adjusting portions adjusting each frequency according to two resonant modes, and having at least one conductive surface, a triple mode resonator including independent adjusting portions adjusting each frequency according to three resonant modes separate from the two resonant modes, and having at least one conductive surface, a first connecting portion electrically connecting the first dual mode and the triple mode resonators, a second dual mode resonator including independent adjusting portions adjusting each frequency according to two resonant modes separate from the two resonant modes and the three resonant modes, and having at least one conductive surface, and a second connecting portion electrically connecting the triple mode resonator and the second dual mode resonator. The three dual mode resonators have similar shapes.

### FIELD OF THE INVENTION

The present invention relates to a diplexer, and resonator filters including a dual-mode resonator and a triple-mode resonator.

### BACKGROUND ART

A filter that only selects a signal of a desired frequency band may be one of indispensable parts of a wireless communication system, and may be one of factors that to hinder miniaturization and cost cutting of the wireless communication system. As the filter used in the wireless communication system, a filter using a lumped element, a micro-strip or strip line filter using a transmission line, a resonator filter, a waveguide filter, a surface acoustic wave (SAW) filter, and the like may be given.

Among the aforementioned various filters, the resonator filter using a cavity that includes a dielectric is mainly used in a microwave band due to a relatively high performance.

A cavity resonator filter may have an appropriate number of resonators and an appropriate combination of structures so as to obtain a desired frequency-response characteristic of the filter. In general, a relatively large number of resonators may be used for a filter to construct a filter having a relatively high rejection characteristic, and using a single-mode resonator may be an issue of reducing a size of a filter. Thus, to miniaturize a filter, a size of a resonator may be reduced, or a number of cavities may be reduced by employing a dual-mode or triple-mode cavity resonator that has several resonant modes in a single cavity.

A high performance filter may be used to meet requirements of a high-quality wireless system performance and a strict performance. However, since a frequency-response characteristic may be responsive to various errors when a filter is constructed, a distortion of a frequency characteristic due to a designing tolerance, manufacturing tolerance, and the like may directly affect a performance of a filter, and a performance standard of a filter may not be satisfied due to a relatively small error. Consequently, a reduced resonator filter requires to easily control a distortion from tuning elements.

### DISCLOSURE OF THE INVENTION

### [Subjects to be Solved]

An aspect of the present invention provides a diplexer, and resonator filters including a dual-mode resonator and a triple-mode resonator that may adjust a frequency according to a resonant mode of a resonator, and correct an error due to a design and a manufacture tolerance.

Another aspect of the present invention provides a diplexer, and resonator filters including a dual-mode resonator and a triple-mode resonator that may reduce a size of a resonator filter.

### [Technical Solutions]

According to an aspect of the present invention, there is provided a 7-pole resonator filter including a dual-mode resonator and a triple-mode resonator, the 7-pole resonator filter including a first dual-mode resonator including independent adjusting portions for adjusting each frequency according to two resonant modes, and having at least one conductive surface, a triple-mode resonator including independent adjusting portions for adjusting each frequency according to three resonant modes which are separate from the two resonant modes, and having at least one conductive surface, a first connecting portion to electrically connect the first dual-mode resonator and the triple-mode resonator, a second dual-mode resonator including independent adjusting portions for adjusting each frequency according to two resonant modes which are separate from the two resonant modes and the three resonant modes, and having at least one conductive surface, and a second connecting portion to electrically connect the triple-mode resonator and the second dual-mode resonator, wherein the first dual-mode resonator, the triple-mode resonator, and the second dual-mode resonator have similar shapes.

According to another aspect of the present invention, there is provided an 8-pole resonator filter including a dual-mode resonator and a triple-mode resonator, the 8-pole resonator filter including a first triple-mode resonator including independent adjusting portions for adjusting each frequency according to three resonant modes, and having at least one conductive surface, a dual-mode resonator including independent adjusting portions for adjusting each frequency according to two resonant modes which are separate from the three resonant modes, and having at least one conductive surface, the first coupling portion to electrically connect the first triple-mode resonator and the dual-mode resonator, a second triple-mode resonator including independent adjusting portions for adjusting each frequency according to three resonant modes which are separate from the three resonant modes formed by the first triple-mode resonator and the two resonant modes, and having at least one conductive surface, and the second coupling portion to electrically connect the dual-mode resonator and the second triple-mode resonator, wherein the first triple-mode resonator, the dual-mode resonator, and the second triple-mode resonator have similar shapes.

According to still another aspect of the present invention, there is provided a 12-pole resonator filter including a dual-mode resonator and a triple-mode resonator, the 12-pole resonator filter including a first dual-mode resonator including independent adjusting portions for adjusting each frequency according to two resonant modes, and having at least one conductive surface, a first triple-mode resonator including independent adjusting portions for adjusting each frequency according to three resonant modes which are separate from the two resonant modes, and having at least one conductive surface, the first coupling portion to electrically connect the first dual-mode resonator and the first triple-mode resonator, a second dual-mode resonator including independent adjusting portions for adjusting each frequency according to two resonant modes which are separate from the two resonant modes formed by the first dual-mode resonator and the three resonant modes, and having at least one conductive surface, the second coupling portion to electrically connect the first triple-mode resonator and the second dual-mode resonator, the second triple-mode resonator including independent adjusting portions for adjusting each frequency according to three resonant modes which are separate from the two resonant modes formed by the first dual-mode resonator, the three resonant modes formed by the first triple-mode resonator, and the two resonant modes formed by the second dual-mode resonator, and having at least one conductive surface, the third coupling portion to electrically connect the second dual-mode resonator and the second triple-mode resonator, the third dual-mode resonator including independent adjusting portions for adjusting each frequency according to three modes which are separate from the two resonant modes formed by the first dual-mode resonator, the three resonant modes formed by the first triple-mode resonator, the two resonant modes formed by the second dual-mode resonator, and the three resonant modes formed by the second triple-mode resonator, and having at least one conductive surface, and a fourth connecting portion to electrically connect the second triple-mode resonator and the third dual-mode resonator, wherein the first dual-mode resonator, the second dual-mode resonator, the third dual-mode resonator, the first triple-mode resonator, and the second triple-mode resonator have similar shapes.

### [Advantageous Effects of the Invention]

According to an embodiment of the present invention, it is possible to dispose adjusting portions on perpendicular surfaces to adjust a resonant frequency of each resonant mode, by alternately using a dual-mode resonator and a triple-mode resonator having similar shapes.

According to another embodiment of the present invention, it is possible to correct an error occurring during a design and a manufacture of a filter by employing an adjusting portion that may adjust a resonant frequency according to each resonant mode.

According to still another embodiment of the present invention, it is possible to correct an error after manufacturing a resonator filter by disposing a connecting portion between resonances.

### BRIEF DESCRIPTION OF THE DRAWINGS

FIG. 1 is a diagram illustrating a shape of a 7-pole resonator filter including two dual-mode resonators and a single triple-mode resonator according to an embodiment of the present invention.

FIG. 2 is a diagram illustrating an electrical configuration of the 7-pole resonator filter of FIG. 1.

FIG. 3 is a diagram illustrating a shape of an 8-pole resonator filter including two triple-mode resonators and a single dual-mode resonator according to an embodiment of the present invention.

FIG. 4 is a diagram illustrating an electrical configuration of the 8-pole resonator filter of FIG. 3.

FIG. 5 is a diagram illustrating an electrical configuration a 12-pole resonator filter including three dual-mode resonators and two triple-mode resonators according to an embodiment of the present invention.

FIG. 6 is a diagram illustrating a shape of a diplexer including two 7-pole resonator filters according to an embodiment of the present invention.

FIG. 7 is a diagram illustrating a shape of a diplexer including two 8-pole resonator filters according to an embodiment of the present invention.

### BEST MODE FOR CARRYING OUT THE INVENTION

Hereinafter, reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. A “resonator filter” described below may refer to a cavity resonator filter.

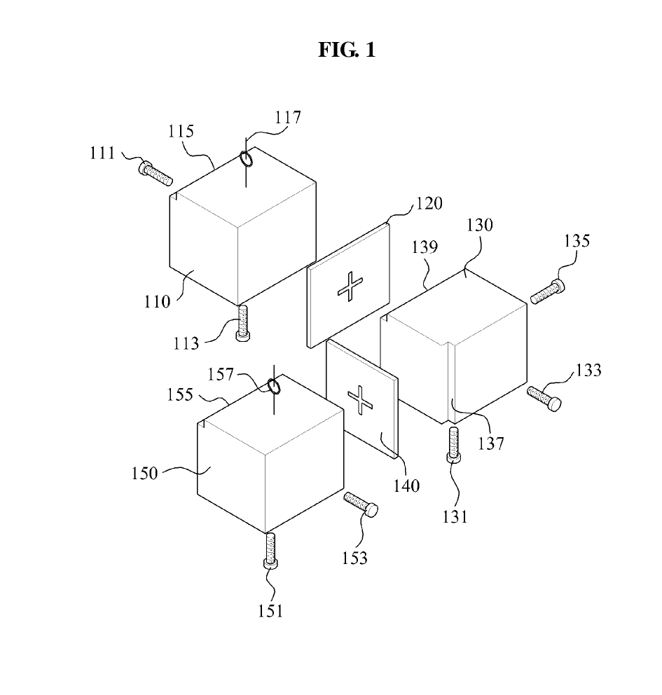

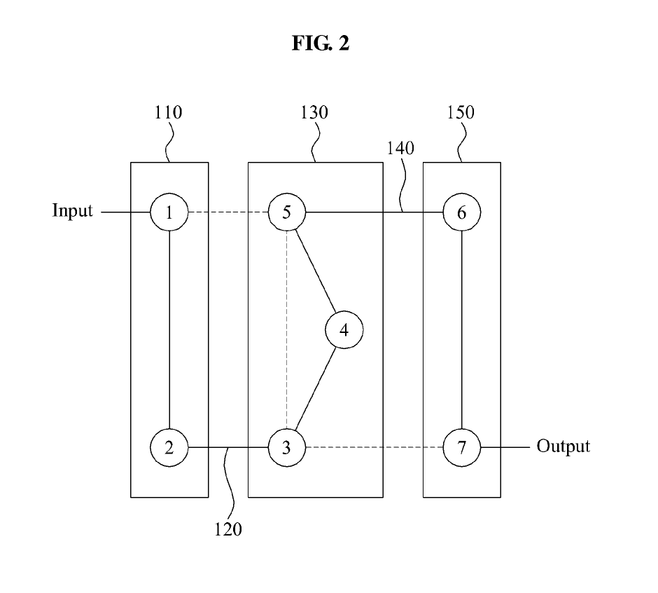

FIG. 1 is a diagram illustrating a shape of a 7-pole resonator filter including two dual-mode resonators and a single triple-mode resonator according to an embodiment of the present invention, and FIG. 2 is a diagram illustrating an electrical configuration of the 7-pole resonator filter of FIG. 1.

Referring to FIG. 1 and FIG. 2, the 7-pole resonator filter may include a first dual-mode resonator 110, a first connecting portion 120, for example, a coupling iris, a triple-mode resonator 130, a second dual-mode resonator 140, and a second connecting portion 150.

The first dual-mode resonator 110 may include two independent adjusting portions 111 and 113 for adjusting each frequency according to two resonant modes, for example, a mode 1 and a mode 2 corresponding to TE₁₀₁ and TE₀₁₁, and may have at least one conductive surface.

The first dual-mode resonator 110 may have a discontinuity portion 115 or a combining screw (not shown) on an edge of a cube, that is, a waveguide having a cubic shape, thereby electrically connecting each mode. Here, the discontinuity portion 115 may correspond to a shape formed by cutting a portion of an edge of the cube.

The first connecting portion 120 may electrically connect the first dual-mode resonator 110 and the triple-mode resonator 130.

The triple-mode resonator 130 may cause resonance at the same frequency for three resonant modes, for example, a mode 3 and a mode 4 corresponding to two TE modes TE₁₀₁ and TE₀₁₁, and a mode 5 corresponding to one TM mode TM₀₁₁.

The triple-mode resonator 130 may include three independent adjusting portions 131, 133, and 135 for adjusting each frequency according to three resonant modes, for example, the mode 3, the mode 4, and the mode 5, and may have at least one conductive surface.

The three resonant modes, for example, the mode 3, the mode 4, and the mode 5 formed by the triple-mode resonator 130 may correspond to resonant modes separate from the two resonant modes, for example, the mode 1 and the mode 2 formed by the first dual-mode resonator 110.

The triple-mode resonator 130 may have discontinuity portions 137 and 139 one two perpendicular edges of a cubic waveguide, and each of the discontinuity portions 137 and 139 may correspond to a shape formed by cutting a portion of an edge of the cube.

The second dual-mode resonator 140 may include two independent adjusting portions 151 and 153 for adjusting each frequency according to two resonant modes, for example, a mode 6 and a mode 7 which are separate from the two resonant modes, for example, the mode 1 and the mode 2 formed by the first dual-mode resonator 110, and are separate from the three resonant modes, for example, the mode 3, the mode 4, and the mode 5 formed by the triple-mode resonator 130, and may have at least one conductive surface. Here, the second dual-mode resonator 150 may include a disconnected portion 155.

The second connecting portion 140 may electrically connect the triple-mode resonator 130 and the second dual-mode resonator 150. The first connecting portion 120 and the second connecting portion 140 may be constructed as coupling irises.

The first dual-mode resonator 110, the triple-mode resonator 130, and the second dual-mode resonator 150 included in the 7-pole resonator filter may have similar shapes, that is, similar heights, widths, and lengths. For example, each of the first dual-mode resonator 110, the triple-mode resonator 130, and the second dual-mode resonator 150 may be formed in a cubic shape in which each surface is conductive using waveguides having the same dielectric.

Here, even though each of the first dual-mode resonator 110, the triple-mode resonator 130, and the second dual-mode resonator 150 included in the 7-pole resonator filter may have a cubic shape, the first dual-mode resonator 110, the triple-mode resonator 130, and the second dual-mode resonator 150 may be described to have similar shapes due to a discontinuity portion formed by cutting a portion of an edge of each cubic shape.

The independent adjusting portions 111 and 113, the independent adjusting portions 131, 133, and 135, and the independent adjusting portions 151 and 153 included in the first dual-mode resonator 110, the triple-mode resonator 130, and the second dual-mode resonator 150, respectively may be installed on at least two perpendicular surfaces of each of the cubic shapes, and may be used to tune a frequency according to each resonant mode.

That is, the adjusting portions 111 and 113 of the first dual-mode resonator 110 may be installed on two perpendicular surfaces, and the independent adjusting portions 151 and 153 of the second dual-mode resonator 150 may be installed on two perpendicular surfaces.

The independent adjusting portions 131, 133, and 135 of the triple-mode resonator 130 may be installed on each of three perpendicular surfaces and thus, the adjusting portions 131 and 133 may be formed on perpendicular surfaces, the adjusting portions 133 and 135 may be formed on perpendicular surfaces, and the adjusting portions 131 and 135 may be formed on perpendicular surfaces.

Each of the adjusting portions of the resonators according to an embodiment of the present invention may be constructed as a tuning screw, and an error occurring during a design and manufacture of a filter may be corrected using the adjusting portions.

The first dual-mode resonator 110 and the second dual-mode resonator 150 of cubic shapes or the triple-mode resonator 130 of a cubic shape may tune resonant frequencies of each resonant mode to correct an error, and the like occurring during a design and a manufacture. The resonant frequencies of each resonant mode may be independently adjusted for each module (resonator) by installing adjusting portions, for example, tuning screws on perpendicular surfaces of the cubic shape.

That is, to tune all modes, the first dual-mode resonator 110 and the second dual-mode resonator 150 may reserve spaces for installing tuning screws on at least two perpendicular surfaces, and the triple-mode resonator 130 may reserve spaces for installing tuning screws on at least three perpendicular surfaces. When three triple-mode resonators are connected in series, one of the resonant modes may not be tuned since a triple-mode resonator in the middle may reserve only two perpendicular surfaces.

However, when a dual-mode resonator is substituted for the triple-mode resonator in the middle, the dual-mode resonator may reserve two perpendicular surfaces, and the two triple-mode resonators may reserve three perpendicular surfaces. That is, a filter having resonators connected in series may be constructed.

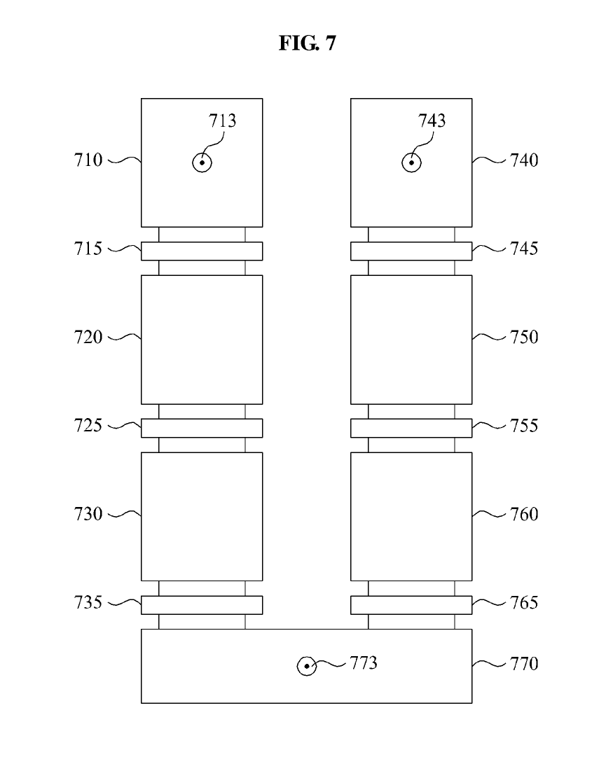

As described in the foregoing, when a filter having resonators connected in series is constructed, a resonator filter may be constructed in various forms, which may be applied to a development of a multiplexer using several filters. An application of the filter having resonators connected in series will be described with reference to a diplexer of FIG. 7.

At least one of the first dual-mode resonator 110, the triple-mode resonator 130, and the second dual-mode resonator 150 may include a dielectric with a relative permittivity greater than 1 in an inside of the at least one of the first dual-mode resonator 110, the triple-mode resonator 130, and the second dual-mode resonator 150.

For example, when a permittivity inside a resonator increases 9 times, a size of a filter may be reduced to one-third of the size. Thus, a size of an overall resonator filter may be reduced by including a dielectric material with a relatively high permittivity in an inside of each resonator including the resonator filter.

At least one of the first dual-mode resonator 110, the triple-mode resonator 130, and the second dual-mode resonator 150 included in the 7-pole resonator filter may exclude a dielectric in an inside of the at least one of the first dual-mode resonator 110, the triple-mode resonator 130, and the second dual-mode resonator 150.

The first dual-mode resonator 110 may be combined with an input port of the 7-pole resonator filter through a first probe 117. The second dual-mode resonator 150 may be combined with an output port of the 7-pole resonator filter through a second probe 157.

Here, the first probe 117 or the second probe 157 may be substituted for by a coupling iris.

The second dual-mode resonator 150 may be connected to the triple-mode resonator 130 to be perpendicular to the first dual-mode resonator 110.

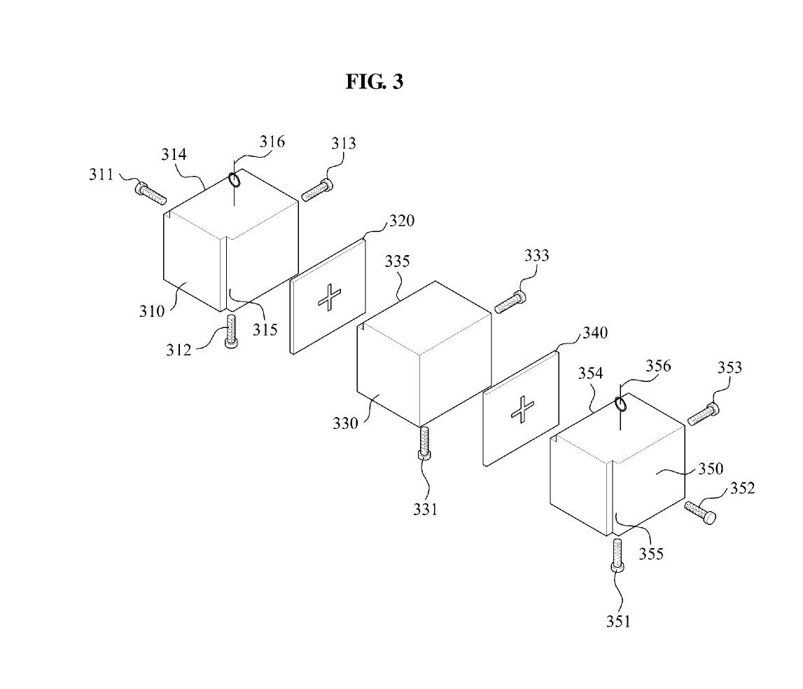

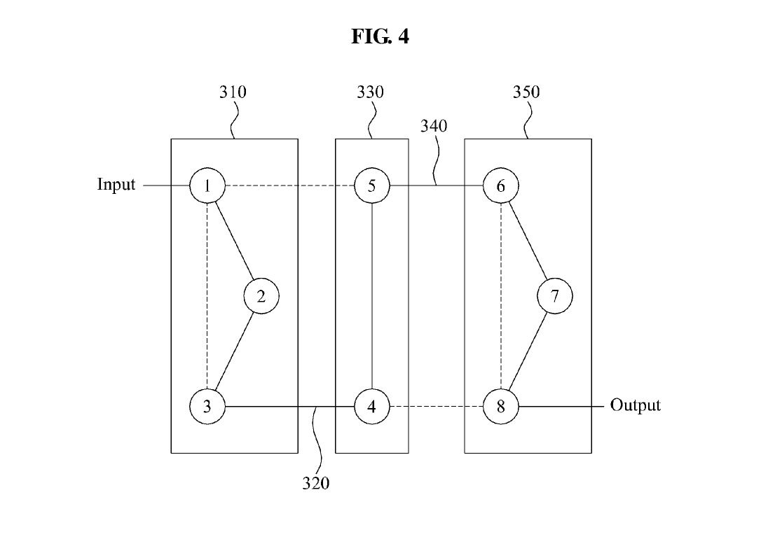

FIG. 3 is a diagram illustrating a shape of an 8-pole resonator filter including two triple-mode resonators and a single dual-mode resonator according to an embodiment of the present invention, and FIG. 4 is a diagram illustrating an electrical configuration of the 8-pole resonator filter of FIG. 3.

FIG. 3 and FIG. 4 illustrate an 8-pole resonator filter including two triple-mode resonators and a single dual-mode resonator. The 8-pole resonator filter may include a first triple-mode resonator 310, a first coupling portion 320, a dual-mode resonator 330, a second coupling portion 340, and a second triple-mode resonator 350.

The first triple-mode resonator 310 may include independent adjusting portions 311, 312, and 313 for adjusting each frequency according to three resonant modes, for example, a mode 1, a mode 2, and a mode 3, and may have at least one conductive surface. The first triple-mode resonator 310 may be combined with an input port of the 8-pole resonator filter through a first probe 316.

The first connecting portion 320 may electrically connect the first triple-mode resonator 310 and the dual-mode resonator 330.

The dual-mode resonator 330 may include independent adjusting portions 331 and 333 for adjusting each frequency according to two resonant modes, for example, a mode 4 and a mode 5 which are separate from the three resonant modes, for example, the mode 1, the mode 2, and the mode 3, and may have at least one conductive surface.

The second coupling portion 340 may electrically connect the dual-mode resonator 330 and the second triple-mode resonator 350.

The second triple-mode resonator 350 may include independent adjusting portions 351, 352, and 353 for adjusting each frequency according to three resonant modes, for example, a mode 6, a mode 7, and a mode 8, and may have at least one conductive surface. The second triple-mode resonator 350 may be combined with an output port of the 8-pole resonator filter through a second probe 356.

Here, the three resonant modes, for example, the mode 6, the mode 7, and the mode 8 formed by the second triple-mode resonator 350 may correspond to modes separate from the three resonant modes, for example, the mode 1, the mode 2, and the mode 3 formed by the first triple-mode resonator 310 and the two resonant modes, for example, the mode 4 and the mode 5 formed by the dual-mode resonator 330.

The first triple-mode resonator 310, the dual-mode resonator 330, and the second triple-mode resonator 350 included in the 8-pole resonator filter may have similar shapes, for example, cubic shapes having similar heights, widths, and lengths in which each surface is conductive using waveguides having the same dielectric.

When the dual-mode resonator 330 is interposed between the first triple-mode resonator 310 and the second triple-mode resonator 350 as illustrated in FIG. 3, eight resonant modes occurring from the first triple-mode resonator 310, the dual-mode resonator 330, and the second triple-mode resonator 350 may be adjusted by each adjusting portion.

Independent adjusting portions of each of the first triple-mode resonator 310, the dual-mode resonator 330, and the second triple-mode resonator 350 included in the 8-pole resonator filter may be installed on at least two perpendicular surfaces of each of the cubic shapes.

That is, the adjusting portions 311, 312, and 313 of the first triple-mode resonator 310 may be installed on three perpendicular surfaces and thus, the adjusting portions 311 and 312 may be formed on perpendicular surfaces, the adjusting portions 312 and 313 may be formed on perpendicular surfaces, and the adjusting portions 311 and 313 may be formed on perpendicular surfaces. The second triple-mode resonator 350 may have a similar configuration to the first triple-mode resonator 310.

The adjusting portions 331 and 333 of the dual-mode resonator 330 may be installed on two perpendicular surfaces.

At least one of the first triple-mode resonator 310, the dual-mode resonator 330, and the second triple-mode resonator 350 may include a dielectric with a permittivity greater than 1 C²/N.m² in an inside of the at least one of the first triple-mode resonator 310, the dual-mode resonator 330, and the second triple-mode resonator 350. As described in foregoing, when a permittivity inside a resonator increases 9 times, a size of a filter may be reduced to one-third of the size.

Thus, a size of an overall resonator filter may be reduced by including a dielectric material with a relatively high permittivity in an inside of each resonator including the 8-pole resonator filter.

At least one of the first triple-mode resonator 310, the dual-mode resonator 330, and the second triple-mode resonator 350 may exclude a dielectric in an inside of the at least one of the first triple-mode resonator 310, the dual-mode resonator 330, and the second triple-mode resonator 350.

The first triple-mode resonator 310, the dual-mode resonator 330, and the second triple-mode resonator 350 may be connected to each other in series in the 8-pole resonator filter. The first triple-mode resonator 310 may include discontinuity portions 314 and 315, the dual-mode resonator 330 may include a discontinuity portion 335, and the second triple-mode resonator 350 may include discontinuity portions 354 and 355.

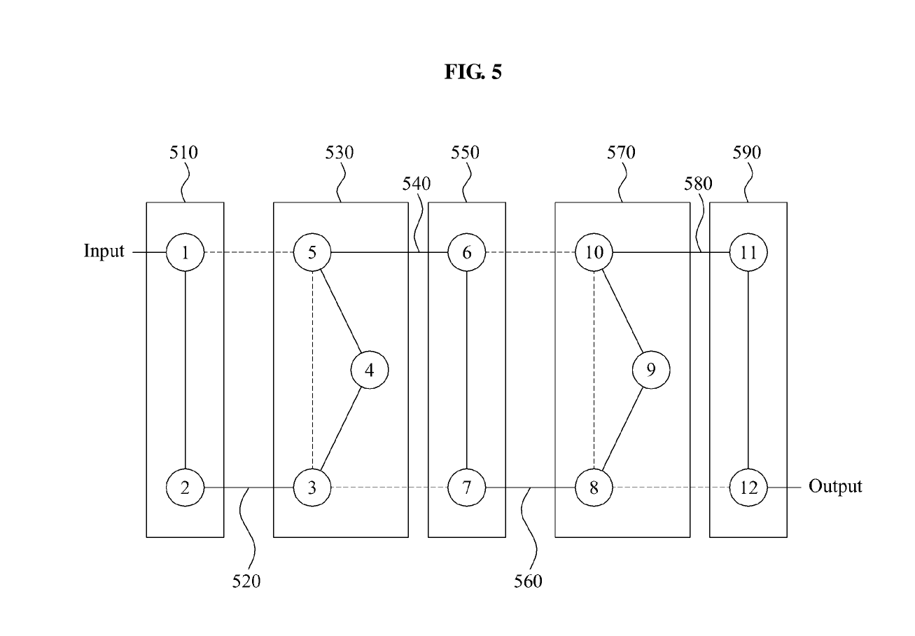

FIG. 5 is a diagram illustrating an electrical configuration a 12-pole resonator filter including three dual-mode resonators and two triple-mode resonators according to an embodiment of the present invention.

Referring to FIG. 5, the 12-pole resonator filter may comprise a first dual-mode resonator 510, a first triple-mode resonator 530, a second dual-mode resonator 550, a second triple-mode resonator 570, and a third dual-mode resonator 590.

The first dual-mode resonator 510 may include independent adjusting portions for adjusting each frequency according to two resonant modes, for example, a mode 1 and a mode 2, and may have at least one conductive surface.

The first triple-mode resonator 530 may include independent adjusting portions for adjusting each frequency according to three resonant modes, for example, a mode 3, a mode 4, and a mode 5 which are separate from the two resonant modes, for example, the mode 1 and the mode 2, and may have at least one conductive surface.

The first dual-mode resonator 510 and the first triple-mode resonator 530 may be connected to each other through a first coupling portion 520 that electrically connects the first dual-mode resonator 510 and the first triple-mode resonator 530.

The second dual-mode resonator 550 may include independent adjusting portions for adjusting each frequency according to two resonant modes, for example, a mode 6 and a mode 7 which are separate from the two resonant modes, for example, the mode 1 and the mode 2 and the three resonant modes, for example, the mode 3, the mode 4, and the mode 5, and may have at least one conductive surface.

The first triple-mode resonator 530 and the second dual-mode resonator 550 may be connected to each other through a second connecting portion 540 that electrically connects the first triple-mode resonator 530 and the second dual-mode resonator 550.

The second triple-mode resonator 570 may include independent adjusting portions for adjusting each frequency according to three resonant modes, for example, a mode 8, a mode 9, and a mode 10 which are separate from the two resonant modes, for example, the mode 1 and the mode 2, the three resonant modes, for example, the mode 3, the mode 4, and the mode 5, and the two resonant modes, for example, the mode 6 and the mode 7, and may have at least one conductive surface.

The second dual-mode resonator 550 and the second triple-mode resonator 570 may be connected to each other through a third coupling portion 560 that electrically connects the second dual-mode resonator 550 and the second triple-mode resonator 570.

The third dual-mode resonator 590 may include independent adjusting portions for adjusting each frequency according to two resonant modes, for example, a mode 11 and a mode 12, and may have at least one conductive surface.

Here, the two resonant modes formed by the third dual-mode resonator 590 may correspond to modes separate from the two resonant modes, for example, the mode 1 and the mode 2 formed by the first dual-mode resonator 510, the three resonant modes, for example, the mode 3, the mode 4, and the mode 5 formed by the first triple-mode resonator 530, the two resonant modes, for example, the mode 6 and the mode 7 formed by the second dual-mode resonator 550, and the three resonant modes, for example, the mode 8, the mode 9, and the mode 10 formed by the second triple-mode resonator 570.

The second triple-mode resonator 570 and the third dual-mode resonator 590 may be connected to each other through a fourth connecting portion 580 that electrically connects the second triple-mode resonator 570 and the third dual-mode resonator 590.

The first dual-mode resonator 510, the first triple-mode resonator 530, the second dual-mode resonator 550, the second triple-mode resonator 570, and the third dual-mode resonator 590 included in the 12-pole resonator filter may have similar shapes.

Here, as described in the foregoing with reference to FIG. 1, each of the first dual-mode resonator 510, the second dual-mode resonator 550, and the third dual-mode resonator 590 may have a discontinuity portion such as the discontinuity portion 115 of FIG. 1 or a combining screw on an edge of a cube, thereby electrically connecting each mode. Here, the disconnected portion on the edge may correspond to a shape formed by cutting a portion of an edge of the cube. Each of the first triple-mode resonator 530 and the second triple-mode resonator 570 may cause resonance at the same frequency for two TE modes TE₁₀₁ and TE₀₁₁ and a single TM mode TM₀₁₁.

Each of the first triple-mode resonator 530 and the second triple-mode resonator 570 may include three independent adjusting portions for adjusting each frequency according to three resonant modes, and may have at least one conductive surface.

Modes of each triple-mode resonator may be connected to each other by forming a discontinuity portion on an edge of a cubic waveguide and thus, discontinuity portions may be formed on two perpendicular edges. The discontinuity portions on the two perpendicular edges may correspond to a shape formed by cutting a portion of an edge of a cube.

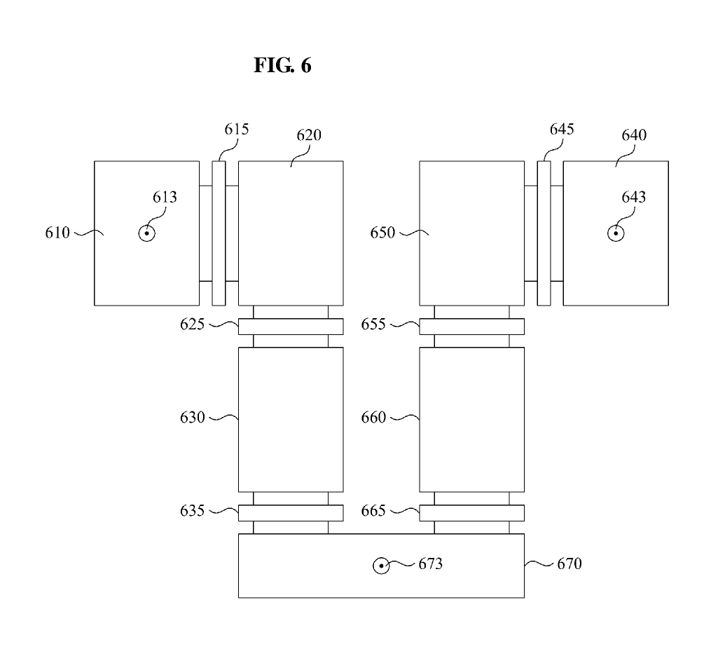

FIG. 6 is a diagram illustrating a shape of a diplexer including two 7-pole resonator filters according to an embodiment of the present invention.

The diplexer may correspond to a device that delivers signals separately output from two circuits to a single circuit without influencing one another.

The diplexer of FIG. 6 may comprise two 7-pole resonator filters illustrated in FIG. 1 that include first dual-mode resonators 610 and 640, first connecting portions 615 and 645, triple-mode resonators 620 and 650, second connecting portions 625 and 655, and second dual-mode resonators 630 and 660, respectively.

Descriptions with reference to FIG. 1 and FIG. 2 may be referred to for each 7-pole resonator filter.

In general, since constructing a diplexer that uses two filters may entail connecting a transmission line to a portion where signals of the two filters are combined or divided, an adjusting portion, for example, a tuning screw may not be installed on a surface to which the transmission line is connected. However, as seen from FIG. 1, the diplexer including two 7-pole resonator filters according to an embodiment of the present invention may have a space for tuning two resonant mode frequencies of each of the second dual-mode resonators 630 and 660 that are connected by connecting portions 635 and 655 and a transmission line 670, formed by a dielectric waveguide, where two signals are combined or divided.

Referring to FIG. 6, when a filter or a diplexer is constructed alternately using a dual-mode resonator and a triple-mode resonator, frequencies of all resonant modes may be tuned using various schemes. A relatively higher-order filter may be minimized using a multi-mode resonator according to an embodiment of the present invention.

Probes 613 and 643 formed on the first dual-mode resonators 610 and 640, respectively, of each of the 7-pole resonator filters may be connected to an input port of the diplexer, and a probe 673 formed on the transmission line 670, formed by a dielectric waveguide, may be connected to an output port of the diplexer. 7-pole resonator filters illustrated in FIG. 1 may be plural, for example, two 7-pole resonator filters may be combined in FIG. 6, and a transmission line may be connected, by a dielectric waveguide, to a portion where signals of a plurality of the 7-pole resonator filters are combined or divided, thereby forming a diplexer.

FIG. 7 is a diagram illustrating a shape of a diplexer including two 8-pole resonator filters according to an embodiment of the present invention.

Referring to FIG. 7, frequencies of eight resonant modes of an 8-pole filter in which each resonator including the 8-pole filter is disposed in series may be individually adjusted, that is, tuned by an adjusting portion, for example, a tuning screw.

The diplexer of FIG. 7 may include two 8-pole resonator filters illustrated in FIG. 3 that include first triple-mode resonators 710 and 740, first coupling portions 715 and 745, dual-mode resonators 720 and 750, second coupling portions 725 and 755, second triple-mode resonators 730 and 760, and third coupling portions 735 and 765, respectively. Descriptions with reference to FIG. 3 and FIG. 4 may be referred to for each 8-pole resonator filter.

8-pole resonator filters may be plural, for example, two 8-pole resonator filters may be including in FIG. 7, and a transmission line 770 may be connected, by a dielectric waveguide, to a portion where signals of a plurality of the 8-pole resonator filters are combined or divided, thereby forming a diplexer.

Referring to FIG. 7, when a filter or a diplexer is constructed alternately using a dual-mode resonator and a triple-mode resonator, frequencies of all resonant modes may be tuned using various schemes. A relatively higher-order filter may be minimized using a multi-mode resonator according to an embodiment of the present invention.

Probes 713 and 743 formed on the first triple-mode resonators 710 and 740, respectively of each of the 8-pole resonator filters may be connected to an input port of the diplexer, and a probe 773 formed on the transmission line 770, formed by a dielectric waveguide, may be connected to an output port of the diplexer.

Descriptions with reference to FIG. 6 may be referred to for further descriptions.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

### EXPLANATION OF REFERENCE NUMERALS

110: first dual-mode resonator

130: triple-mode resonator

150: second dual-mode resonator

What is claimed is:

1. A 7-pole resonator filter comprising a dual-mode resonator and a triple-mode resonator, the 7-pole resonator filter comprising:
a first dual-mode resonator including independent adjusting portions for adjusting each frequency according to two resonant modes, and having at least one conductive surface;
a triple-mode resonator including independent adjusting portions for adjusting each frequency according to three resonant modes which are separate from the two resonant modes, and having at least one conductive surface;
a first coupling portion to electrically connect the first dual-mode resonator and the triple-mode resonator;
a second dual-mode resonator including independent adjusting portions for adjusting each frequency according to two resonant modes which are separate from the two resonant modes and the three resonant modes, and having at least one conductive surface; and
a second coupling portion to electrically connect the triple-mode resonator and the second dual-mode resonator,
wherein the first dual-mode resonator, the triple-mode resonator, and the second dual-mode resonator have similar shapes.

2. The 7-pole resonator filter of claim 1, wherein:
the similar shapes correspond to cubic shapes, and
the adjusting portions are installed on at least two perpendicular surfaces of each of the cubic shapes.

3. The 7-pole resonator filter of claim 1, wherein:
the first dual-mode resonator comprises one of an input port, a first probe, and a third coupling portion of the 7-pole resonator filter, and
the second dual-mode resonator comprises one of an output port, a second probe, and a fourth coupling portion of the 7-pole resonator filter.

4. The 7-pole resonator filter of claim 1, wherein the second dual-mode resonator is clamped to the triple-mode resonator to be perpendicular to the first dual-mode resonator.

5. The 7-pole resonator filter of claim 1, wherein at least one of the first dual-mode resonator, the triple-mode resonator, and the second dual-mode resonator includes a dielectric with a relative permittivity greater than 1 in an inside of the at least one of the first dual-mode resonator, the triple-mode resonator, and the second dual-mode resonator.

6. The 7-pole resonator filter of claim 1, wherein at least one of the first dual-mode resonator, the triple-mode resonator, and the second dual-mode resonator excludes a dielectric in an inside of the at least one of the first dual-mode resonator, the triple-mode resonator, and the second dual-mode resonator.

7. The 7-pole resonator filter of claim 1, wherein 7-pole resonator filters are plural, and a transmission line is connected, by a dielectric waveguide, to a portion where signals of a plurality of the 7-pole resonator filters are combined or divided, thereby forming a diplexer.

8. An 8-pole resonator filter comprising a dual-mode resonator and a triple-mode resonator, the 8-pole resonator filter comprising:
a first triple-mode resonator including independent adjusting portions for adjusting each frequency according to three resonant modes, and having at least one conductive surface;
a dual-mode resonator including independent adjusting portions for adjusting each frequency according to two resonant modes which are separate from the three resonant modes, and having at least one conductive surface;
a first connecting portion to electrically connect the first triple-mode resonator and the dual-mode resonator;
a second triple-mode resonator including independent adjusting portions for adjusting each frequency according to three resonant modes which are separate from the three resonant modes formed by the first triple-mode resonator and the two resonant modes, and having at least one conductive surface; and
a second connecting portion to electrically connect the dual-mode resonator and the second triple-mode resonator,
wherein the first triple-mode resonator, the dual-mode resonator, and the second triple-mode resonator have similar shapes.

9. The 8-pole resonator filter of claim 8, wherein:
the similar shapes correspond to cubic shapes, and
the adjusting portions are installed on at least two perpendicular surfaces of each of the cubic shapes.

10. The 8-pole resonator filter of claim 8, wherein at least one of the first triple-mode resonator, the dual-mode resonator, and the second triple-mode resonator includes a dielectric with a relative permittivity greater than 1 in an inside of the at least one of the first triple-mode resonator, the dual-mode resonator, and the second triple-mode resonator.

11. The 8-pole resonator filter of claim 8, wherein at least one of the first triple-mode resonator, the dual-mode resonator, and the second triple-mode resonator excludes a dielectric in an inside of the at least one of the first triple-mode resonator, the dual-mode resonator, and the second triple-mode resonator.

12. The 8-pole resonator filter of claim 8, wherein the first triple-mode resonator, the dual-mode resonator, and the second triple-mode resonator are connected to each other in series.

13. The 8-pole resonator filter of claim 8, wherein 8-pole resonator filters are plural, and a transmission line is connected, by a dielectric waveguide, to a portion where signals of a plurality of the 8-pole resonator filters are combined or divided, thereby forming a diplexer.

14. A 12-pole resonator filter comprising a dual-mode resonator and a triple-mode resonator, the 12-pole resonator filter comprising:
a first dual-mode resonator including independent adjusting portions for adjusting each frequency according to two resonant modes, and having at least one conductive surface;
a first triple-mode resonator including independent adjusting portions for adjusting each frequency according to three resonant modes which are separate from the two resonant modes, and having at least one conductive surface;
a first coupling portion to electrically connect the first dual-mode resonator and the first triple-mode resonator;
a second dual-mode resonator including independent adjusting portions for adjusting each frequency according to two resonant modes which are separate from the two resonant modes formed by the first dual-mode resonator and the three resonant modes, and having at least one conductive surface;
a second coupling portion to electrically connect the first triple-mode resonator and the second dual-mode resonator;
a second triple-mode resonator including independent adjusting portions for adjusting each frequency according to three resonant modes which are separate from the two resonant modes formed by the first dual-mode resonator, the three resonant modes formed by the first triple-mode resonator, and the two resonant modes formed by the second dual-mode resonator, and having at least one conductive surface;
a third coupling portion to electrically connect the second dual-mode resonator and the second triple-mode resonator;
a third dual-mode resonator including independent adjusting portions for adjusting each frequency according to three resonant modes which are separate from the two resonant modes formed by the first dual-mode resonator, the three resonant modes formed by the first triple-mode resonator, the two resonant modes formed by the second dual-mode resonator, and the three resonant modes formed by the second triple-mode resonator, and having at least one conductive surface; and
a fourth coupling portion to electrically connect the second triple-mode resonator and the third dual-mode resonator,
wherein the first dual-mode resonator, the second dual-mode resonator, the third dual-mode resonator, the first triple-mode resonator, and the second triple-mode resonator have similar shapes.

15. The 12-pole resonator filter of claim 14, wherein the similar shapes correspond to cubic shapes.

16. The 12-pole resonator filter of claim 14, wherein at least one of the first dual-mode resonator, the second dual-mode resonator, the third dual-mode resonator, the first triple-mode resonator, and the second triple-mode resonator includes a dielectric with a relative permittivity greater than 1 in an inside of the at least one of the first dual-mode resonator, the second dual-mode resonator, the third dual-mode resonator, the first triple-mode resonator, and the second triple-mode resonator.

17. The 12-pole resonator filter of claim 14, wherein at least one of the first dual-mode resonator, the second dual-mode resonator, the third dual-mode resonator, the first triple-mode resonator, and the second triple-mode resonator excludes a dielectric in an inside of the at least one of the first dual-mode resonator, the second dual-mode resonator, the third dual-mode resonator, the first triple-mode resonator, and the second triple-mode resonator.
